(19) United States
(12) Patent Application Publication
(10) Pub. No.: US 2004/0208180 A1
(43) Pub. Date: Oct. 21, 2004

(54) System and method for supporting auto-negotiation among standards having different rates

(76) Inventors: Allen Miles Light, Bend, OR (US); Howard Anthony Baumer, Laguna Hills, CA (US)

Correspondence Address: MCANDREWS HELD & MALLOY, LTD, 500 WEST MADISON STREET, SUITE 3400, CHICAGO, IL, 60661

(21) Appl. No.: 10/414,593

(22) Filed: Apr. 15, 2003

(51) Int. Cl. H04L 12/56

(52) U.S. Cl. 370/395.2; 370/535

(57) ABSTRACT

A system and method are provided to support auto-negotiation between at least two communication devices among standards having different data rates. Base page configuration information and next page configuration information are exchanged between the at least two communication devices at a first data rate over a single serial channel. Ability matching is performed by the at least two communication devices using the base page and next page configuration information. A communication link is established between the at least two communication devices over the single serial channel at a negotiated first data rate, or over multiple parallel serial channels at a negotiated second effective data rate, depending on at least a result of the ability matching.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Embodiments of the present invention relate generally to a system and method for supporting auto-negotiation. More specifically, the present invention relates to a system and method for supporting auto-negotiation among standards having different rates.

The term Ethernet refers to a family of local area network (alternatively referred to as “LAN”) implementations that includes three principal categories: (i) Ethernet and IEEE 802.3 are LAN specifications that operate at about 10 megabits per second (alternatively referred to as “Mbps”) over, for example, thick and thin coaxial cable, or twisted pair cable; (ii) 100-Mbps Ethernet, a single LAN specification that operates at 100 Mbps over fiber and twisted-pair cables (alternatively referred to as Fast Ethernet because it is 10 times faster than the older 10 Mbps standard) and is defined in IEEE standard 802.3u which is incorporated herein by reference in its entirety; and (iii) 1000-Mbps Ethernet, a single LAN specification (alternatively referred to as “Gigabit Ethernet” or “GBE”) that operates at 1000 Mbps or 1 Gpbs over fiber and twisted-pair cables. Ethernet has survived as an essential media technology because of its tremendous flexibility and its relative simplicity to implement and understand. Although other technologies are touted as likely replacements, network managers continually turn to Ethernet and its derivatives as effective solutions for a range of implementation requirements.

Differences between Ethernet and IEEE 802.3 LANs are subtle. Ethernet provides services corresponding to Layers 1 and 2 of the OSI reference model. IEEE 802.3 specifies the physical layer (Layer 1) and the channel-access portion of the link layer (Layer 2), but does not define a logical link control protocol. Both Ethernet and IEEE 802.3 are typically implemented in hardware. The physical manifestation of these protocols is either an interface card in a host computer or circuitry on a primary circuit board within a host computer. IEEE 802.3 specifies several different physical layers, whereas Ethernet defines only one. Each 802.3 physical layer has a name that summarizes its characteristics. Such names include, for example, 10Base5, 10Base2, 1Base5, 10BaseT, and 10Broad36. 10Base2 is the physical layer most similar to Ethernet and has characteristics including a 10 Mbps data rate, a baseband signaling method, a maximum segment length of 500 feet, a 50-ohm coax connection media, and a bus topology. The IEEE standard 802.3 and IEEE 802.3u and any supplements, referred to throughout this document, are each incorporated herein by reference in their entirety.

Auto-negotiation as defined in the IEEE standard 802.3u 100Base-T supplement, Clause 28 makes it possible for data communication devices to exchange information about their abilities over a link segment. This, in turn, enables the devices to perform automatic configuration to achieve the best possible mode of operation over a link. At a minimum, auto-negotiation may provide automatic speed matching for multi-speed communication devices at each end of a link. Multi-speed Ethernet interfaces may then take advantage of the highest speed offered by a multi-speed hub port.

Thus, auto-negotiation enables a data communication device to select the best transmission speed and transmission mode based on capabilities of the device at the opposite side of the link. For example, a first device may support transmission at 10 Mbps and 100 Mbps in half-duplex and full-duplex modes, while a second device connected to the first device may support 100 Mbps full-duplex mode. Since both ends of the link support 100 Mbps full-duplex mode, the first device selects this mode. However, if a third device connected to the first device only supports 10 Mbps half-duplex mode, the first device automatically detects these capabilities, and selects 10 Mbps half-duplex mode.

Similarly, clause 37 of the IEEE standard in 802.3 defines auto-negotiation capability in 1000 Base-X devices. Such definition enables 1000 Base-X devices to self-configure to a jointly compatible operating mode. Additionally, such definition provides a mechanism for an auto-negotiation device to advertise its abilities and detect the abilities of the connected link partner

Clause 37 of IEEE standard 802.3-2002 describes an auto-negotiation function for 1000Base-X communications. However, clause 37 does not define auto-negotiation for a device having, for example, 10 Gigabit Ethernet capability implemented in a XAUI (10 Gigabit Extended Attachment Unit Interface) configuration. IEEE standard 802.3-2000 is incorporated herein by reference in its entirety.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

Embodiments of the present invention relate generally to a system and method for supporting auto-negotiation up to data rates higher than previously specified for auto-negotiation.

Various embodiments of the present invention provide a system and method for configuring connections between network devices, in particular those including Ethernet compliant devices. One embodiment of the present invention relates to a system and method that accommodates both 1000Base-X and XAUI configurations and enables selection between the two. Additionally, one embodiment of the present invention enables 10 Gigabit switchblades to accommodate legacy 1 Gigabit nodes, extending the compatibility and interoperability between 3.1 cards and promoting 10 Gigabit switch (i.e., fabric) support. Other embodiments of the present invention enable XAUI capable ports to power up in 1000 Base-X mode and enter an auto-negotiation sequence. Still other embodiments of the present invention enable using a “next page” function in a configuration register, advertising XAUI capability in a message page format, and supercede the normal clause 37 priority resolution function if both sides are XAUI capable.

One embodiment of the present invention relates to a system and method adapted to support auto-negotiation between at least two communication devices. This embodiment comprises transmitting at least one next page in a transmit configuration register.

Yet another embodiment of the present invention relates to a system and method adapted to support auto-negotiation among standards having different data rates. This embodiment comprises performing at least one of master reset, plug in, power on, reset and out of sync functions and transmitting configuration information. The configuration information is received and acknowledged. The availability of at least one next page is determined. XAUI compatibility and XAUI communication success may also be determined, and at least one bit of data is transmitted.

These and other advantages, aspects and novel features of the present invention, as well as details of an illustrated embodiment thereof, will be more fully understood from the following description and drawings.

### BRIEF DESCRIPTION OF THE DRAWINGS

FIG. 1 is a block diagram illustrating auto-negotiation between two communication devices in accordance with an embodiment of the present invention.

FIG. 2 illustrates a block diagram of a single-channel chassis and backplane in accordance with an embodiment of the present invention.

FIG. 3 illustrates a block diagram of a backplane of a chassis having a plurality of channels in accordance with an embodiment of the present invention.

FIG. 4 illustrates the single-channel of the backplane of the chassis of FIG. 2 in accordance with an embodiment of the present invention.

FIG. 5 illustrates the multiple channels of the backplane of the chassis of FIG. 3 in accordance with an embodiment of the present invention.

FIGS. 6A and 6B illustrate a detailed flow chart depicting a method for auto-negotiating among standards having different rates in accordance with an embodiment of the present invention.

### DETAILED DESCRIPTION OF THE INVENTION

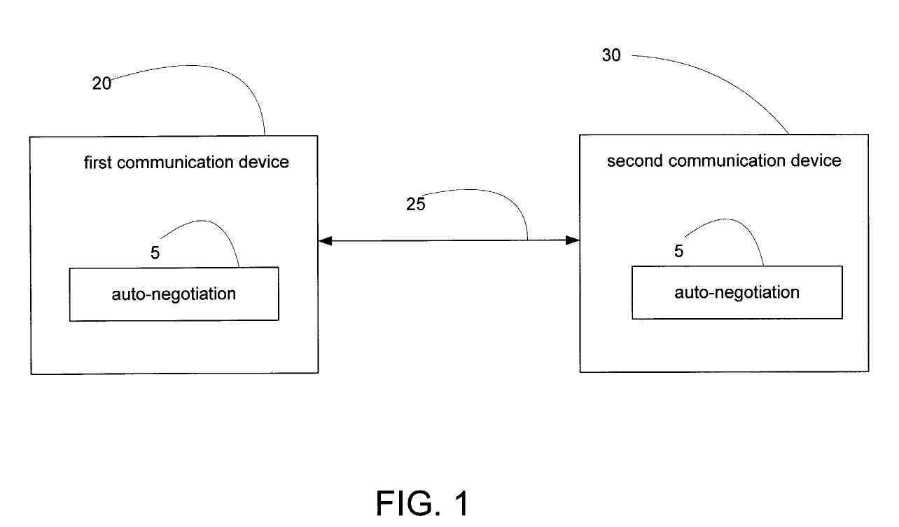

Referring to FIG. 1, in accordance with an embodiment of the present invention, an auto-negotiation method 5 enables a first communication device 20 to advertise its potential modes of operation to a second communication device 30 that may be remote from the first communication device but connected to the first communication device 20 via a communication link 25. In a similar manner, the first communication device 20 is able to detect potential operational modes advertised by the second communication device 30. The communication link 25 may comprise copper or optical fiber in accordance with an embodiment of the present invention.

A goal of the auto-negotiation method 5 is to exchange information between the two communication devices 20 and 30 (such as network interface cards (NIC's)), over a communication link 25 and configure the communication devices 20 and 30 to take advantage of their maximum capabilities, if possible. The auto-negotiation method 5 does not test the characteristics of the communication link 25, however.

In accordance with an embodiment of the present invention, the auto-negotiation function 5 allows the linked communication devices 20 and 30 to advertise capabilities, acknowledge receipt and understanding of capabilities and modes of operation shared by both communication devices 20 and 30, and reject the use of modes and capabilities not common to both communication devices 20 and 30.

In accordance with an embodiment of the present invention, when more than one mode or capability is common to both communication devices 20 and 30, the auto-negotiation method 5 allows the communication devices 20 and 30 to negotiate to a single mode of operation. In accordance with an embodiment of the present invention, the auto-negotiation method 5 allows the communication devices 20 and 30 to be switched between operational modes in a logical manner, permits a management function to enable or disable auto-negotiation capability, and allows a specific operational mode to be selected.

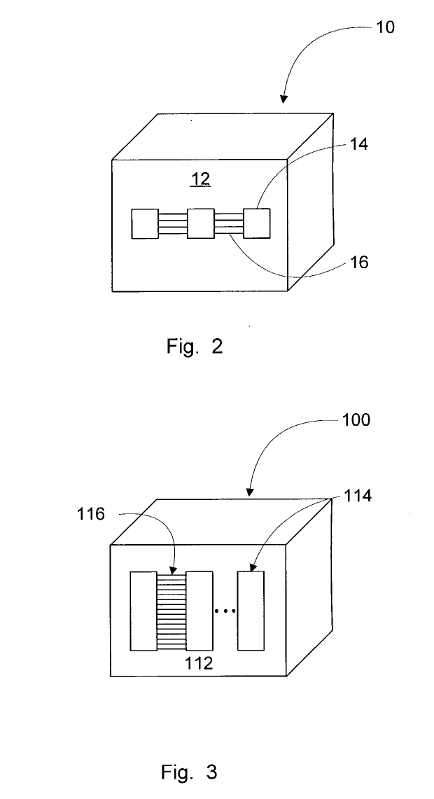

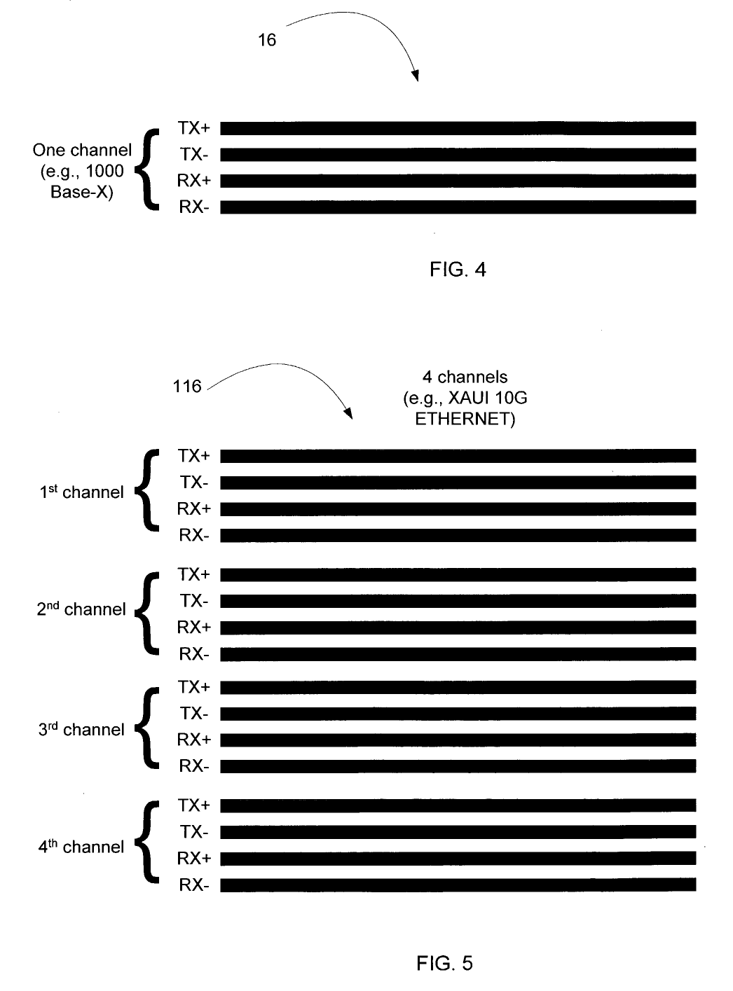

FIG. 2 illustrates a block diagram of a single-channel chassis 10 having a backplane 12 in accordance with an embodiment of the present invention. In accordance with an embodiment of the present invention, the chassis 10 and backplane 12 are used in a blade environment of a communication system. The backplane 12 comprises one or more connectors 14 (to plug NIC's into, for example, and operating at, for example, 10 Mbps, 100 Mbps, or 1 Gbps) having four wires comprising a single channel 16. The four wires comprise two twisted pair pathways, in accordance with an embodiment of the present invention. A first twisted pair pathway comprises two wires (TX+ and TX−) for transmitting serial data, and a second twisted pair pathway comprises two wires (RX+ and RX−) for receiving serial data. FIG. 4 illustrates the single-channel 16 of the backplane 12 of the chassis 10 of FIG. 2 in accordance with an embodiment of the present invention.

FIG. 3 illustrates a block diagram of a backplane 112 of a chassis 100 having a plurality of channels 116 in accordance with an embodiment of the present invention. In accordance with an embodiment of the present invention, the chassis 100 and backplane 112 are used in a blade environment of a communication system. The backplane 112 comprises one or more connectors 114 (to plug NIC's into, for example, operating at, for example, 1 Gbps or 10 Gbps) having sixteen wires comprising four parallel channels 116 in accordance with an embodiment of the present invention.

Each of the four parallel channels comprises four wires and the four wires comprise two twisted pair pathways. A first twisted pair pathway comprises two wires (TX+ and TX−) for transmitting serial data, and a second twisted pair pathway comprises two wires (RX+ and RX−) for receiving serial data. FIG. 5 illustrates the four parallel channels 116 of the backplane 112 of the chassis 100 of FIG. 3 in accordance with an embodiment of the present invention. Such a configuration may be used for 10 Gigabit Ethernet communications, for example, in a XAUI-compatible format. Also, such a configuration allows for the design of XAUI compatible cards that are backwards compatible with, for example, 1 Gigabit nodes.

The chassis 10 and backplane 12 of FIG. 2 only supports a single channel 16 of TX and RX twisted pairs. Therefore, only a single channel of serial data transmission and reception is supported typically at, for example, 10 Mbps, 100 Mbps, 1.25 Gbps, or some other standard data rate. The chassis 10 and backplane 12 do not support XAUI compatible communications.

Since the chassis 100 and backplane 112 support four parallel pathways of TX and RX twisted pairs, the four parallel pathways 116 may provide one or more single serial channels (up to four), operating at, for example 10 Mbps, 100 Mbps, 1.25 Gbps or some other standard data rate. Alternatively, the four parallel pathways may support a single XAUI compatible channel (using all four parallel pathways 116) in accordance with an embodiment of the present invention. The XAUI compatible channel uses all 16 wires (all four pathways) and may support 10 Gigabit Ethernet operation where each parallel pathway operates at, for example, 3.125 Gbps.

When a XAUI compatible NIC is plugged into, for example, the chassis 100, the auto-negotiation method 5 may be used to negotiate a communication link between the NIC and another communication device (e.g., another NIC) to operate at, for example, either 1.25 Gbps (Gigabit Ethernet) or 10 Gigabit Ethernet XAUI. Clause 37 of IEEE Standard 802.3 -2000 does not currently provide the capability to negotiate to 10 Gigabit Ethernet XAUI operation.

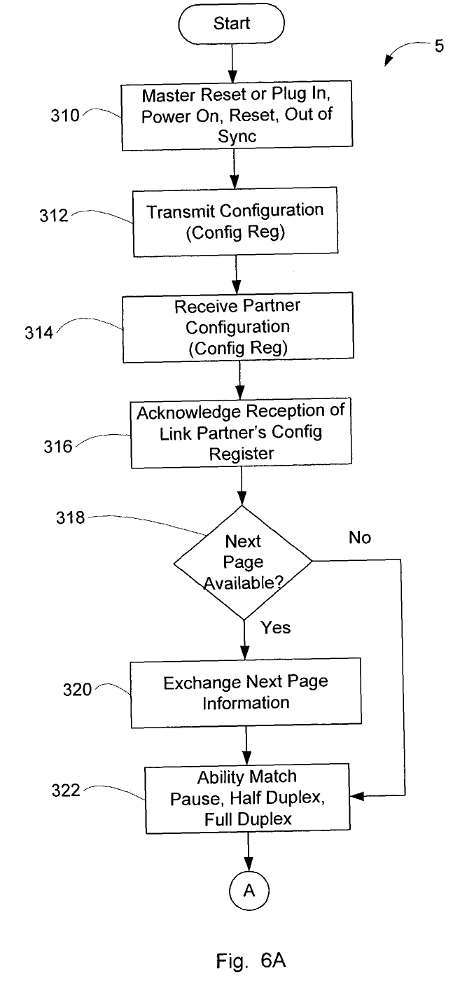

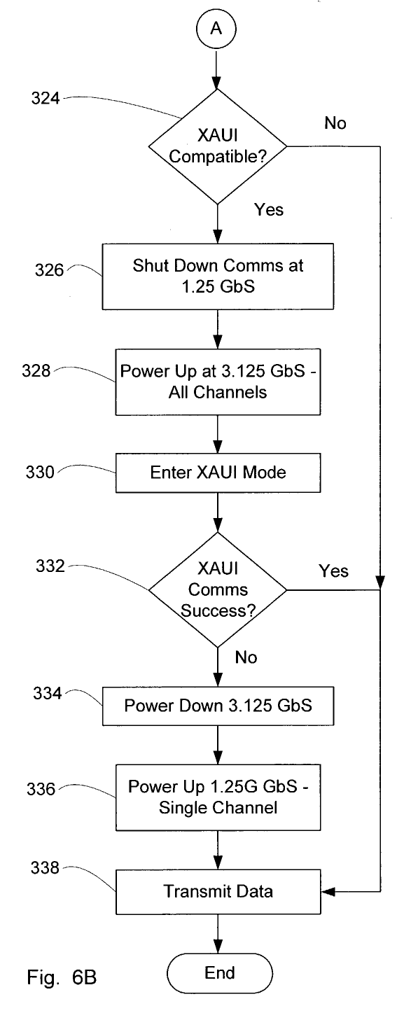

FIGS. 6A and 6B illustrate a detailed flow chart depicting an auto-negotiation method 5 for auto-negotiating among standards having different rates in accordance with an embodiment of the present invention. In step 310, method 5 comprises performing a master reset or plug in, power on, reset, and out of sync functions, of a first communication device 20 (e.g., a first NIC) and a second communication device 30 (e.g., a second NIC), among other features, similar to clause 37.

In step 312, the method 5 further comprises transmitting configuration information, such as base page configuration information, from the first communication device 20 to the second communication device 30 and vice versa at a data rate of, for example, 1.25 Gbps over one of the four parallel channels 16 (i.e., over a single serial channel). The base page configuration information comprises certain operational information about the communication devices 20 and 30 (e.g., duplex and pause capability) including next page functionality.

Similarly, in step 314 configuration information, such as base page configuration information, is received by each communication device 20 and 30 from the other at, for example, 1.25 Gbps. In step 316, the communication devices 20 and 30 acknowledge receipt of the configuration information from each other.

In step 318, the communication devices 20 and 30 determine, from the received base page configuration information, if next page configuration information is available from the other communication device. If not, then the method skips to step 322 and performs ability matching. If so, then the two communication devices exchange next page configuration information, in step 320, similarly to how they exchanged base page configuration information.

In accordance with an embodiment of the present invention, a XAUI compatible communication device will embed a message code in the next page configuration information to convey to the other communication device that it is XAUI compatible. If next page configuration information is not available from one of the communication devices, then it is assumed that the communication device is not XAUI compatible and negotiation to XAUI operation will not be attempted.

During step 322, ability matching is done to determine half duplex capability, full duplex capability, and pause capability, similar to the ability matching functions defined in clause 37. In step 324, the auto-negotiation method 5 determines if the communication devices are XAUI compatible. If not, then a full communication link is established between the first communication device 20 and the second communication device 30 at, for example, the 1.25 Gbps data rate in step 338. In other words, no further attempt is made to establish a XAUI-configured communication link at 10 Gbps. Data transmission and reception occurs between the two communication links at 1.25 Gbps. At this point, the auto-negotiation process is complete.

If, however, step 324 of the auto-negotiation method 5 determines that the two communication devices 320 and 330 are XAUI compatible, then the method 5 proceeds to step 326 where 1.25 Gbps communication over the single serial channel (i.e., one of the four parallel channels) is shut down. In step 328, the XAUI compatible communication devices are powered up using all four parallel channels, each operating at 3.125 Gbps according to the XAUI standard. In step 330, the XAUI operational mode is selected and entered by the two communication devices.

In step 332, an attempt is made to establish XAUI communication between the two communication devices 20 and 30. If the attempt is successful, then data transmission and reception proceeds, in step 338, between the two communication devices 20 and 30 using the XAUI channel that comprises the four parallel channels 116 each operating at 3.125 Gbps. At this point, the auto-negotiation process is complete.

If the attempt is not successful, then communication between the two communication channels at 3.125 Gbps is shut down in step 334. In step 336, the two communication devices are again powered up at 1.25 Gbps using a single serial channel (i.e., just one of the four parallel channels). Data transmission and reception then proceeds, in step 338, between the two communication devices 20 and 30 using the single serial channel at 1.25 Gbps. At this point, the auto-negotiation process is complete.

Embodiments of the present invention allow auto-negotiation between combinations of other standard data rates as well using either single or multiple channels.

In summary, a system and method are provided to support auto-negotiation between at least two communication devices among standards having different data rates by extending the functionality of the auto-negotiation capability defined in clause 37 of IEEE standard 802.3-2002.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

What is claimed is:

1. A method for supporting auto-negotiation between at least two communication devices, said method comprising:
exchanging base page configuration information and/or next page configuration information between said at least two communication devices at a first data rate over a single serial channel;
performing ability matching using said base page configuration information and/or next page configuration information within each of said at least two communication devices; and
establishing a communication link between said at least two communication devices over said single serial channel at a negotiated first data rate, or over multiple parallel serial channels at a negotiated second effective data rate, depending on at least a result of said ability matching.

2. The method of claim 1 wherein said first data rate and said negotiated first data rate correspond to a 1000 Base-X transmission.

3. The method of claim 1 wherein said negotiated second effective data rate corresponds to a 10 Gigabit Ethernet XAUI transmission.

4. The method of claim 1 wherein said multiple parallel serial channels comprise a XAUI configuration of four parallel serial channels.

5. The method of claim 1 wherein said ability matching comprises determining if said at least two communication devices each support XAUI functionality.

6. The method of claim 1 wherein said exchanging base page configuration information comprises:
transmitting said base page configuration information at said first data rate;
receiving said base page configuration information at said first data rate;
acknowledging reception of said base page configuration information; and
determining availability of a next page.

7. The method of claim 1 wherein said establishing said communication link over said multiple parallel serial channels at said negotiated second effective data rate comprises:
shutting down communications over said single serial channel at said first data rate;
powering up said multiple parallel serial channels at said negotiated second effective data rate;
entering a XAUI communication mode;
determining that XAUI communications over said multiple parallel serial channels is successful; and
transmitting at least one bit of data over said multiple parallel serial channels at said negotiated second effective data rate.

8. The method of claim 1 wherein said establishing said communication link over said single serial channel at said negotiated first data rate comprises:
shutting down communications over said single serial channel at said first data rate;
powering up said multiple parallel serial channels at said negotiated second effective data rate;
entering a XAUI communication mode;
determining that XAUI communications over said multiple parallel serial channels is not successful;
shutting down communications over said multiple parallel serial channels at said negotiated second effective data rate;
powering up said single serial channel at said negotiated first data rate; and
transmitting at least one bit of data over said single serial channel at said negotiated first data rate.

9. The method of claim 1 wherein said establishing said communication link over said single serial channel at said negotiated first data rate comprises:
determining, via said ability matching, that at least one of said at least two communication devices is not XAUI compatible;
transmitting at least one bit of data over said single serial channel at said negotiated first data rate.

10. The method of claim 1 wherein said negotiated first data rate and said negotiated second effective data rate comprise standard data rates.

11. The method of claim 1 wherein said at least two communication devices each comprise network interface cards (NIC's).

12. The method of claim 1 wherein said exchanging next page configuration information comprises:
transmitting said next page configuration information at said first data rate;
receiving said next page configuration information at said first data rate;
acknowledging reception of said next page configuration information; and
determining availability of another next page.

13. The method of claim 1 further comprising performing at least one of a master reset, plug in, power on, reset, and out of sync functions.

14. The method of claim 1 wherein said ability matching comprises determining half duplex capability, full duplex capability, and pause capability of each of said at least two communication devices.

15. The method of claim 1 wherein said first data rate and said negotiated first data rate are at or near 1.25 Gbps.

16. The method of claim 1 wherein each channel of said multiple parallel serial channels supports a data rate at or near 3.125 Gbps.

17. The method of claim 1 wherein said negotiated second effective data rate is at or near 10 Gbps.

18. The method of claim 1 wherein said next page configuration information comprises at least one formatted message code to convey XAUI configuration compatibility.

19. The method of claim 1 wherein said single serial channel comprises four paths at a backplane of each of said at least two communication devices, and wherein said four paths comprise a TX+path, a TX−path, a RX+path, and a RX−path.

20. The method of claim 1 wherein each channel of said multiple parallel serial channels comprise four paths at a backplane of each of said at least two communication devices, and wherein said four paths comprise a TX+path, a TX−path, a RX+path, and a RX−path.
